(19) United States
(12) Patent Application Publication
(10) Pub. No.: US 2001/0015079 A1
(43) Pub. Date: Aug. 23, 2001

(54) Method for producing dopant doped high pure silica Glass

(75) Inventors: Keun-Deok Park, Kwangyokshi (KR); Dong-Juon Kim, Koyang-shi (KR); Won-Il Jeong, Kumi-shi (KR); Hyung-Min Lee, Pohang-shi (KR)

Correspondence Address: KLAUBER & JACKSON, 411 HACKENSACK AVENUE, HACKENSACK, NJ, 07601

(73) Assignee: SAMSUNG ELECTRONIC CO., LTD

(21) Appl. No.: 09/748,948

(22) Filed: Dec. 27, 2000

(30) Foreign Application Priority Data
Dec. 28, 1999 (KR) 1999-64123

(51) Int. Cl. C03B 8/02

(52) U.S. Cl. 65/17.2

(57) ABSTRACT

A method for producing a dopant doped high pure silica glass comprising the steps of: preparing powder by dispersing silica particles into a dispersion medium; adding a dopant containing gas; drying, heating and pulverizing the same in sequence to produce dopant doped silica powder; and, producing a dopant doped silica glass by using the silica powder produced by said powder preparing step as a starting substance.

### CLAIM OF PRIORITY

This application makes reference to and claims all benefits accruing under 35 U.S.C. Section 119 from an application entitled “METHOD FOR PRODUCING DOPANT DOPED HIGH PURE SILICA GLASS” filed in the Korean Industrial Property Office on Dec. 28, 1999 and there duly assigned Serial No. 99-64123.

### BACKGROUND OF THE INVENTION

1. Field of the Invention

The invention relates to a method for producing a silica glass, and in particular to a method for fabricating a high-purity silica glass using a sol-gel process.

2. Description of the Related Art

In general, optical transmission fiber typically contains a high-purity silica glass core doped with a reflective index-adjusting element, such as germanium. Silica glass is well known to have a high level of thermal stability and strength. In some manufacturing processes, the core/cladding are fabricated by a variety of known methods, such as modified chemical vapor-phase deposition(MCVD) and sol-gel method. The composition of the fiber product can be controlled using the sol-gel process as a liquid phase process. In contrast to other methods, the sol-gel process is very economical as it is performed at a relatively low temperature.

In particular, a metal alkoxide compound is generally used to dope the silica glass in the sol-gel process. The metal alkoxide compounds, despite having the advantage of being able to provide a uniformly doped silica glass, has some drawbacks in that cracking and shrinking can occur after the sintering process. Hence, it is a continuous journey to find a method that is effective in preventing cracking during the drying process of the gel.

### SUMMARY OF THE INVENTION

It is an object of the invention to provide a high-purity silica glass, in which cracking and shrinking caused by the dopant materials are suppressed.

Accordingly, to achieve the above objective, the present invention provides a method for fabricating a silica glass comprising the steps of: preparing powder by dispersing silica particles into a dispersion medium and then adding dopant containing gas to be dried, heated, and pulverized to produce starting powder materials to fabricate a high density silica glass.

Another object of the present invention is to provide a method for producing a doped silica glass comprising the steps of: dispersing fumed silica in deionized water; agitating the fumed silica dispersed in the water while adding a dopant containing gas; drying the agitated product to form a dry gel; calcining the dry gel via a heat application while supplying with a gas for removing impurities; pulverizing the calcined product into particles of predetermined size; mixing and redispersing the pulverized silica powder in the deionized water to form a sol; aging the sol at room temperature to stabilize the sol and remove bubbles in the sol; pouring the aged gel into a mold forming into a predetermined shape; demolding the molded gel; drying the demolded gel at a first predetermined temperature and level of umidity to form a dry gel; applying a first heat treatment to the dried gel at a second predetermined temperature to remove organic materials in the dried gel; and, applying a second heat treatment at a sintering temperature to vitrify the first heat treated dried gel.

Another object of the present invention is to apply a ultrasonic wave into the mixture of the fumed silica and the deionized water.

### BRIEF DESCRIPTION OF THE DRAWINGS

The above objective and advantage of the present invention will be readily understood by those skilled in the art upon reading the following detailed description in conjunction with the drawing, wherein:

FIG. 1 shows a flow for producing a high-purity silica glass doped with a dopant according to a preferred embodiment of the invention.

### DETAILED DESCRIPTION OF THE PREFERRED EMBODIMENT

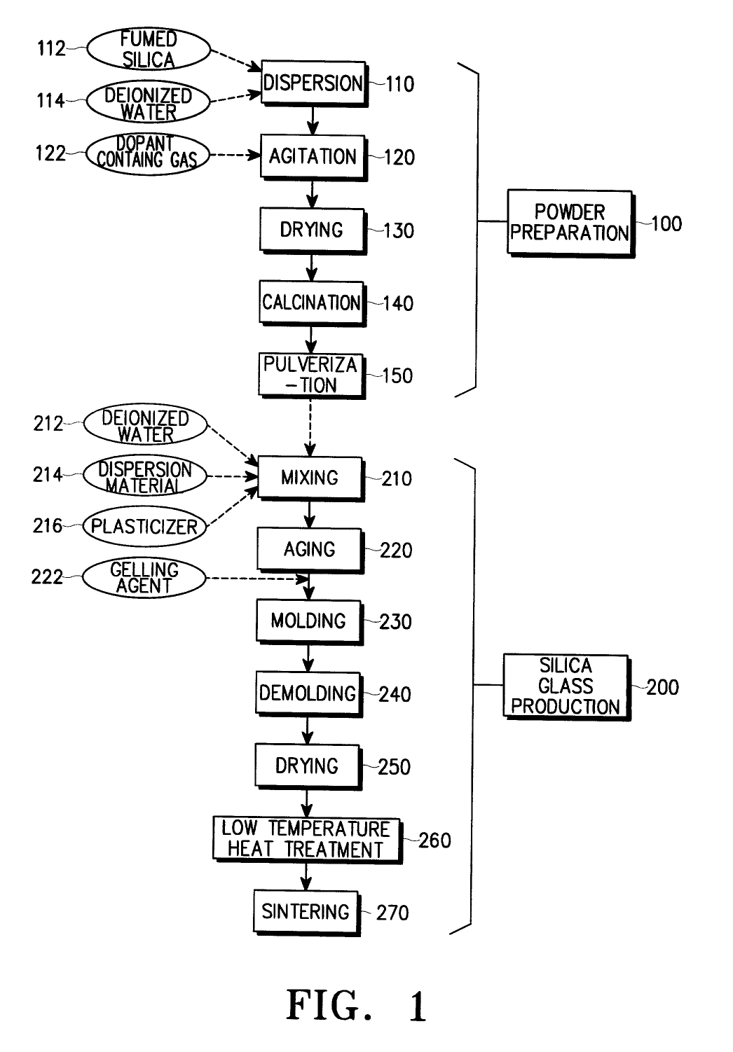

Hereinafter, preferred embodiments of the invention will be described in detail in reference to FIG. 1, which shows a flow for producing a high-purity silica glass in which cracking and shrinking are reduced.

As shown in FIG. 1, the inventive method for producing a high-purity silica glass doped with a dopant comprises two main steps of: preparation of the silica powder 100 and fabrication of a silica glass 200, wherein each of the steps has a plurality of sub-steps. To be specific, the invention is characterized by using silica powder prepared by dispersing fumed silica in deionized water, adding dopant containing gas to the dispersed fumed silica, drying, calcinating, and pulverizing the solution in sequence to produce the high-purity silica glass.

With reference to FIG. 1, each step involved in the power preparation process 100 according to the present invention is described in detail below.

1. Preparation of the Silica Powder

In the dispersing step 110, fumed silica 112 is dispersed in deionized water 114. The dispersing step 110 is performed by using an ultrasonic wave to provide a sufficient dispersion effect. The content of the fumed silica used in the dispersing step 110 is preferably below 50 wt. % based on the weight of dispersion (or sol).

In the agitation step 120, the solution obtained in the dispersing step 110 is agitated while being doped with dopant containing gas 122. Any dopant including a halogen element (i.e., GeCl4, GeBr4, GeI2, GeF4, etc.) is applicable in the present invention. A chlorine gas compound is preferably used as the dopant containing gas 122 in the agitating step 120. A dopant with CL easily react with water and converted into fine particles to be applied to the fumed silica particles. For example, the gas phase GeCl4 is doped to produce a germanium doped silica glass. Here, the GeCl4 is converted into Ge(OH)4 via hydrolysis reaction. By doping the dopant containing gas 122 into the sufficiently dispersed fumed silica 112 in the deionized water during the agitation step 120, the gaseous dopant can be uniformly doped.

In the drying step 130, the product agitated in the step 120 is dried. When the product is doped with a suitable amount of gas, the agitation is stopped, the doped product is filled into a vessel to be moved to a drying means, such as a dry chamber. The drying step 130 is carried out at below 100° C.

In the calcination step 140, the dry gel produced via the drying step 130 is heated and supplied with gas for removing impurities. For example, gases such as oxygen, helium, chlorine, or etc. can be used for removing the impurities in this step. The calcination step 140 is carried out by inputting the dry gel into an independent drying means and heating the same at a temperature up to 900° C.

In the pulverizing step 150, the resulting product from the calcination step 140 is pulverized into fine particles with a uniform size to produce silica powder, which is uniformly doped. The pulverizing step 150 is carried out by inputting the product of the calcination step 140 into a pulverizer to smash or pulverize the same into a suitable size, then passing the pulverized powder through a sieve to obtain silica powder having a uniform particle size. The silica powder is a product formed by pulverizing a gelled sol, which is uniformly doped in the silica particles.

2. Producing Silica Glass

The silica glass producing step 200 is a procedure in which the silica powder produced via the powder preparing step 100 is used as starting materials to produce a doped silica glass.

The silica glass producing step 200 according to the present invention comprises the sub-steps of mixing 210, aging 220, molding 230, demolding 240, drying 250, low temperature heat treating 260 and sintering 270.

In the mixing step 210, the silica powder produced via step 100 is mixed with deionized water and dispersed in deionized water to form a sol. Also, a dispersion material 214 and a plasticizer 216 are added in the mixing step 210. An organic base is used as the dispersion material 214. The dispersion material 214 serves to increase the hydrogen ion concentration (pH) of the sol, thereby improving the dispersion capacity of the sol so that physical properties of the final product or the silica glass may be improved. The plasticizer 216 guarantees flexibility when the sol is being gelled, so that a stress that is induced to the gel when the gel is dried can be reduced.

In the aging step 220, the sol is aged at room temperature so that particles are stabilized and bubbles in the sol can be removed.

In the molding step 230, the sol is poured into a mold and formed into a predetermined shape.

In the demolding step 240, the wet gel is removed from the mold. The demolding step 240 can be carried out by using water pressure in a water bath to prevent damage to the wet gel.

In the drying step 250, the separated wet gel is dried at a predetermined temperature and level of humidity to form a dry gel. The drying step 250 is carried out in a thermohydrostat chamber.

In the low temperature heat treating step 260, the dry gel is heated to remove organic materials in the dry gel. The dry gel is heat treated while being supplied with gases including chlorine, hydrogen, oxygen and etc., in order to dissolve organic materials, including residual moisture and binders in the dry gel, and to remove metallic impurities, hydroxide(OH) group, etc.

In the sintering step 270, the organic-material-removed dry gel is heated up to a sintering temperature for vitrification. The dry gel, which was heat treated at a low temperature in step 260, is sintered and vitrified to produce a doped high-purity silica glass. The sintering step 270 is carried out by heating the dry and organic material treated gel up to the temperature of 1300 to 1400° C. using a furnace in a helium gas atmosphere. The furnace is translated up and down during the heat application along the suspended the doped silica glass. After finishing the sintering step 270, a high-purity silica glass is obtained to have a uniformly doped silica glass, in which cracking is suppressed.

As described hereinabove, the method for producing a high-purity silica glass utilizes a silica powder that is uniformly doped with a dopant material as a starting material for producing a silica glass so that a finally produced silica glass is uniformly doped with a dopant and low cracking and shrinking can be obtained.

What is claimed is:

1. A method for producing a doped silica glass comprising the steps of:
(a) preparing starting powder by dispersing silica particles into a dispersion medium, adding a dopant containing gas, and drying, heating and pulverizing the resulting product in sequence to produce doped silica powder; and
(b) producing the doped silica glass using said silica powder by redispersing the resulting product in the dispersion medium to form a sol, said sol is subsequently gelated, molded, and sintered.

2. A method for producing a doped silica glass comprising the steps of:
(a) dispersing fumed silica in deionized water;
(b) agitating the fumed silica dispersed in the water while adding a dopant containing gas;
(c) drying the agitated product to form a dry gel;
(d) calcining the dry gel via a heat application while supplying with a gas for removing impurities;
(e) pulverizing the calcined product into particles of predetermined size;
(f) mixing and redispersing the pulverized silica powder in the deionized water to form a sol;
(g) aging the sol at room temperature to stabilize the sol and remove bubbles in the sol;
(h) pouring the aged gel into a mold forming into a predetermined shape;
(i) demolding the molded gel;
(j) drying the demolded gel at a first predetermined temperature and level of humidity to form a dry gel;
(k) applying a first heat treatment to the dried gel at a second predetermined temperature to remove organic materials in the dried gel; and
(l) applying a second heat treatment at a sintering temperature to vitrify the first heat treated dried gel.

3. The method as recited in claim 2, wherein the dispersing step (a) comprises applying a ultrasonic wave into the mixture of the fumed silica and the deionized water.

4. The method as recited in claim 2, wherein the fumed silica used in the dispersing step (a) is below 50 wt. % based on the deionized water.

5. The method as recited in claim 2, wherein the drying steps (c) and (d) are carried out below 100° C.

6. The method as recited in claim 2, wherein the calcining step (d) comprises heating the dried gel up to 900° C.

7. The method as recited in claim 2, wherein the dopant containing gas used in the agitating step (b) is a chlorine gaseous compound.

8. The method as recited in claim 7, wherein the chlorine gaseous compound is GeCl4.
